(19) United States
(12) Patent Application Publication
(10) Pub. No.: US 2016/0107513 A1
(43) Pub. Date: Apr. 21, 2016

(54) Vehicle Roof

(71) Applicant: WEBASTO SE, Stockdorf (DE)

(72) Inventors: Gerhard Skorianz, Maisach (DE); Thomas Sichart, Jesenwang (DE); Stephan Kugler, Munchen (DE)

(21) Appl. No.: 14/894,225

(22) PCT Filed: Apr. 23, 2014
(86) PCT No.: PCT/EP2014/058198

§ 371 Date: Nov. 25, 2015

(30) Foreign Application Priority Data
May 27, 2013 (DE) 10 2013 008 898.4

(51) Int. Cl. B60J 7/043; B60J 7/057

(52) U.S. Cl. CPC B60J 7/043; B60J 7/0573

(57) ABSTRACT

The present invention relates to a vehicle roof having a first and a second sunshade arrangement or a first and a second cover for closing a respectively associated opening in the vehicle roof, the sunshade arrangements or the covers being arranged one behind another in the roof longitudinal direction, and it being possible for them to be displaced by at least one drive means which is guided in a manner which is resistant to compression. The drive means is guided in the region of the first sunshade arrangement or the first cover in a first guide channel of a first guide rail, and is guided in the region of the second sunshade arrangement or the second cover in a second guide channel of a second guide rail. According to the invention, a transfer component is provided which transfers the drive means from the first to the second guide channel in a manner which is free from kinks.

The present invention relates to a vehicle roof in accordance with the preamble of claim 1.

Vehicle roofs having a first and a second sunshade arrangement which are arranged one behind another in the longitudinal direction and can be displaced by at least one drive means which is guided in a manner which is resistant to compression, the drive means being guided in the region of the first sunshade arrangement in a first guide channel of a first guide rail, and being guided in the region of the second sunshade arrangement in a second guide channel of a second guide rail, are known. Corresponding sunshade arrangements serve to shade transparent regions of a vehicle roof DE 10 2004 020 335 A1 discloses a sunshade system having a rear blind arrangement and a front blind arrangement which are installed at the same level in the vehicle roof The installation of two blind arrangements is necessary, in particular, when two roof modules which are separate from one another are to be installed in a vehicle having a B-pillar transverse strut in the shell structure. In known vehicle roofs, the guide rails of the modules are then arranged in an aligned manner. The drive means, for example a drive cable, runs from an outlet opening of the front guide rail of the module which lies at the front in the driving direction rectilinearly into an inlet opening of a second guide rail of the rear roof module. Instead of two blind arrangements which are arranged one behind another, however, a drive cable can also displace two covers which lie one behind another and are provided to close in each case one associated opening in the vehicle roof.

A disadvantage in known embodiments of this type is the fact that the installation space below the guide rail in the rear roof module and therefore the headroom in the rear region of the vehicle are predefined by way of the guide curve or the guide height of the drive means in the front roof module. Different horizontal spacings of the guide rails in the front and rear region of the vehicle roof likewise cannot be realized, since once again the guide curve of the drive means in the region of the rear roof module is predefined by way of the guide curve of the drive means in the region of the front roof module.

It is therefore an object of the present invention to provide a vehicle roof, in which the abovementioned disadvantages are overcome.

This object is achieved by way of a vehicle roof as claimed in claim 1.

According to the invention, a transfer component is provided which transfers a drive means from the first to the second guide channel in a manner which is free from kinks.

As a result of the provision of a transfer component, the guide channel in a first guide rail which is assigned to a first sunshade arrangement or a first cover can be arranged at a different level (vertical position from the vehicle floor) and/or width (horizontal position in the vehicle transverse direction) than a second guide channel in a second guide rail which is assigned to the second sunshade arrangement or the second cover. The guide channels can therefore be arranged offset with respect to one another. However, they also can be oriented such that they are not aligned with one another, since the transfer component nevertheless makes a transfer which is free from kinks possible. For example, it can thus be ensured that a second sunshade arrangement in the region of a rear bench of the vehicle can be installed at a greater height (relative to the vehicle floor) if, for example, the headroom for the passengers seated in the rear is to be increased, or if different seat positions which are given by the front and by the rear seats require this. In the case of a vehicle with a B-pillar transverse strut in the shell structure, furthermore, two roof modules which are separate from one another can be installed one after another, it being possible for the transfer component to transfer the drive means into the rear roof module in a simple way during assembly, but also during operation in the case of a displacement of the sunshade arrangements. Different widths of sunshade arrangements and/or covers can also be realized, however, if, for example, the vehicle roof becomes narrower toward the rear.

Preferred embodiments of the invention result from the subclaims.

Whereas in principle two sunshade arrangements or covers might be moved by means of merely one drive means, two drive means are preferably provided which are arranged in a region on the left and right (in the driving direction) of the vehicle roof and which are moved synchronously, in order to displace the first and the second sunshade arrangement (or associated roller blinds) or covers.

The transfer component preferably imparts to the drive means a predefined guide curve from the first to the second guide channel. This affords the advantage that the drive means does not leave a predefined guide curve during a movement through the transfer component, the guide curve being configured in such a way that kink-free guidance of the drive means is ensured. Here, the guide curve can be selected, for example, in such a way that, in order to deflect the drive means from the first guide channel into the second guide channel, the guide curve does not undershoot minimum permissible radii, in order to avoid kinking of the drive means or excessive frictional losses.

The first and the second guide channel can be arranged offset with respect to one another in the vertical and/or horizontal direction. Furthermore, in a region of an outlet opening which is assigned to the second guide channel, the first guide channel can be oriented so as to not be aligned with respect to the second guide channel in the region of an inlet opening which is assigned to the first guide channel. This affords a great design scope for the positioning and orientation of the guide rails and channels, the transfer component ensuring the kink-free guidance and transfer of the drive means.

In a further preferred embodiment of the invention, the guide curve forms an S-bend in the vertical direction. Here, an “S-bend” is to be understood to mean a bend of the transfer component with two curvatures which are oriented in opposite directions and are thus configured in such a way that a rectilinear starting section of the guide curve is transferred into an end section of the guide curve, which end section is parallel with respect to said starting section and likewise runs rectilinearly. Accordingly, a transfer component according to the invention guides a drive means such that the drive means first of all runs rectilinearly into the transfer component and is then deflected twice by way of the transfer component in such a way that it once again leaves the transfer component rectilinearly along a line which runs parallel to the first line, but offset vertically and/or laterally (horizontally) with respect to the latter. The double deflection is defined by way of two curvatures with opposite directions of curvature, the curvatures not undershooting a minimum radius which ensures that, although the drive means is deflected continuously, it is not kinked.

Here, the guide curve can be configured in such a way that it is configured as an S-bend only in the vertical or only in the horizontal direction and therefore offsets the drive means merely vertically or laterally (horizontally; in the vehicle transverse direction) by means of two curvatures.

Therefore, for example, the drive means which leaves the first, front guide rail is initially deflected upward (or else downward) by means of a first curvature, and is subsequently deflected again in the opposite direction in such a way that the course of the drive means during the entry into the second guide rail or into the guide channel of said second guide rail is once again rectilinear, but is offset upward (or downward) with respect to the course in the first guide rail.

In a further embodiment, the guide curve is configured as an S-bend in the vertical and horizontal direction. This means that the guide means can be offset both vertically and horizontally (transversely with respect to the vehicle longitudinal axis) in the region of the second guide rail and connects the transfer component at the outlet opening of the first (front) guide channel to an inlet opening of the second guide channel. In each case one corresponding S-bend can therefore be seen in a projection of the transfer component or in a view from above and from the side of the transfer component.

In a further preferred embodiment of the invention, the transfer component is configured as an alternation and is equipped with a transfer channel which lies on the inside and is configured to guide the drive means. This means that the transfer component does not completely enclose a guide channel for the drive means as a small closed tube or cylinder, but rather always only in the form of a part cylinder and alternating in the longitudinal extent in each case in one section from a first side and in a following section only from the opposite side. This affords an essential advantage during injection molding of the transfer component, since no mandrel or slide has to be provided in the corresponding mold for injection molding the transfer component, in order to configure a closed tube or a closed cylinder. This results in substantial simplifications during the manufacture of a transfer component of this type.

In a further preferred embodiment of the invention, the transfer component is of tubular configuration, for example injection molded with a transfer guide channel which lies on the inside and is configured for guiding the drive means. The transfer component is therefore a rigid tube which preferably forms two curvatures and advantageously has a round internal diameter which permits guidance of the flexible drive means.

In a further preferred embodiment of the invention, the transfer component has a hose piece which receives the drive means, and a reinforcing element, by means of which the flexible hose piece is fixed in the predefined guide curve. This affords the advantage that the hose piece firstly ensures that the drive means can be guided with as little friction as possible. Secondly, the reinforcing element ensures that the drive means cannot deform the hose piece in such a way that it deviates from the predefined guide curve to such a pronounced extent that it is kinked or is not transferred in an optimum manner from the first guide channel into the second guide channel.

In a further preferred refinement of the present invention, the sunshade arrangements are blind arrangements, and the roller blinds of the blind arrangements are further preferably unwound from in each case one winding shaft by the drive means. Here, the winding shafts are assigned restoring springs which build up an increasing spring force counter to the unwinding direction as unwinding of the roller blind from the winding shaft progresses. Said restoring springs serve firstly to ensure that the roller blinds always remain tautly stressed. Secondly, the restoring force assists rolling up of the roller blinds onto the winding shafts. It can also be provided, however, that both or, in particular, the rear roller blind are/is rolled up again only by way of the restoring spring of the associated winding shaft. This can ensure that the drive means merely has to push a tension bow of the roller blind in front of it during extension, with the result that the tension bow which is arranged at that end of the roller blind which faces away from the winding shaft is moved by virtue of the fact that the end of the drive means bears against it, and unwinds the roller blind. When the drive means is withdrawn again, the tension bow follows the end of the drive means as a result of the spring force of the associated restoring spring. This affords the advantage that the drive means, for example in the case of the rear blind arrangement, that is to say the blind arrangement which is further remote from a drive of the drive means, does not have to latch with a driver or the tension bow of said roller blind, as a result of which latching and unlatching means can be dispensed with. As an alternative, it can also be provided that the drive means can withdraw a tension bow of a roller blind again. As a result, the spring force of the restoring spring can be of smaller dimensions, since the spring merely has to control the winding-up movement of the winding shaft, but the moving back of the tension bow is at least assisted by way of active pulling of the drive means.

As alternatives to blind arrangements, the sunshade arrangements can also have in each case one sliding headliner which can be configured such that it can be displaced in one piece or in multiple pieces in a slat-like manner.

In the following text, examples of the invention will be explained in greater detail by way of example with reference to the appended drawings, in which:

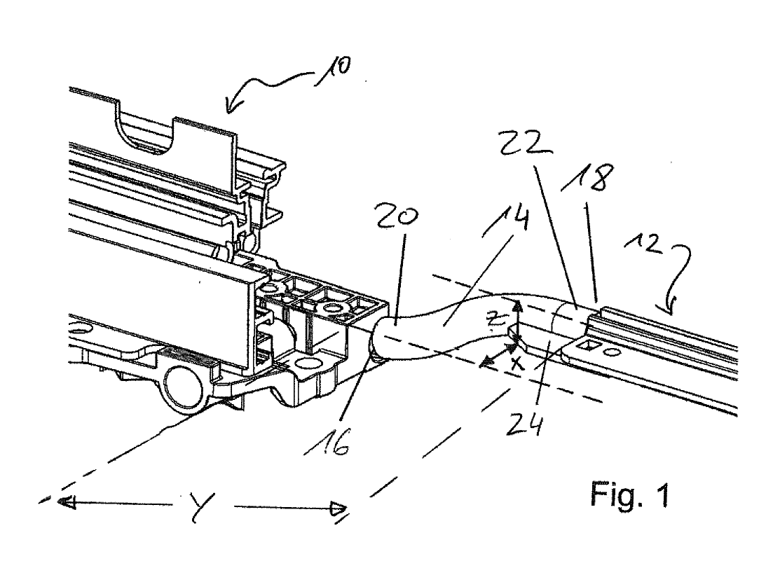

FIG. 1 shows a diagrammatic view of a blind system according to the invention,

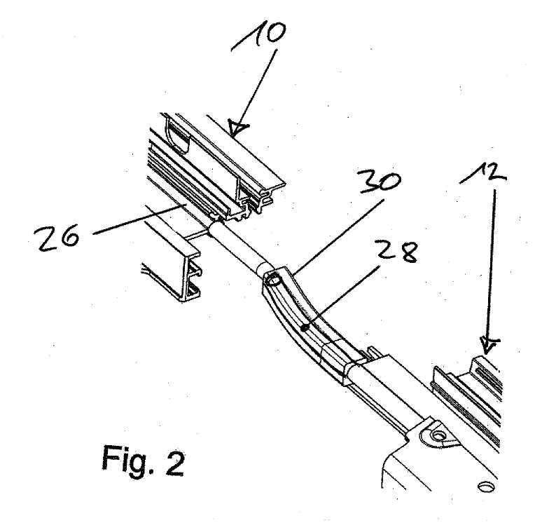

FIG. 2 shows an alternative embodiment of a blind system according to the invention, and

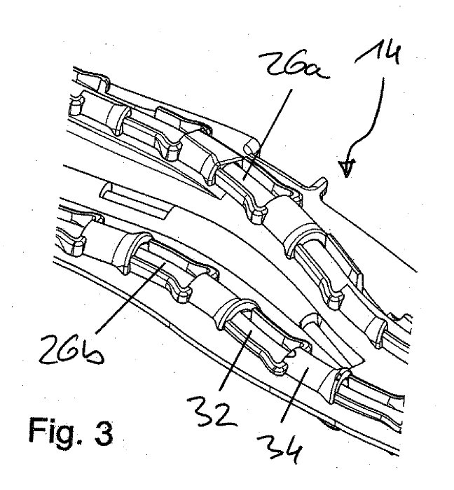

FIG. 3 shows a further embodiment of a transfer component for use in a blind system according to the invention.

In FIG. 1, two guide rails 10 and 12 of a blind system according to the invention are depicted. The two guide rails 10 and 12 are arranged in a vehicle in such a way that the guide rail 10 is mounted in a front region of the vehicle roof and the rear guide rail 12 is mounted in a rear roof region. The vehicle roof can be, in particular, a vehicle roof consisting of two roof modules which are separate from one another. Separate roof modules of this type can be installed, for example, in a vehicle having a B-pillar transverse strut, a front and a rear roof module being installed behind one another in front of and behind the B-pillar transverse strut, respectively. Here, in the embodiment of FIG. 1, the B-pillar transverse strut is arranged between the two guide struts 10 and 12, with the result that it is therefore advantageous that no continuous guide rail is used, but rather that merely a transfer component 14 is installed in the region of the B-pillar transverse strut. Here, the transfer component 14 connects a first guide channel of the first guide rail 10 to a second guide channel of the second guide rail 12 in such a way that a drive cable, which (cannot be seen in FIG. 1) leaves the guide channel of the guide rail 10 through its outlet opening 16, is guided in a manner which is free from kinks in the interior of the transfer component 14 into the guide channel of the guide rail 12 or its inlet opening 18. In addition to kink-free transfer of the drive cable from the first guide rail 10 into the second guide rail 12, a transfer component according to the invention also affords the advantage that, after assembly of the front (in the driving direction) roof module which is situated in the region of the front guide rail 10, the drive cable merely has to be advanced out of the outlet opening 16 of the guide rail 10, and the transfer component 14 then transfers the drive cable into the inlet opening 18 of the rear guide rail 12.

According to the illustration of FIG. 1, the two guide rails 10 and 12 are arranged so as not to be aligned behind one another, but rather the rear guide rail 12 or, in particular, its guide channel is arranged at a vertical spacing Z above a straight line which is defined by the first guide channel of the front guide rail 10. Here, the vertical spacing Z is measured in a direction from the vehicle floor in the direction of the vehicle roof It is preferably from 0.1 to 20 cm.

As can likewise be gathered from FIG. 1, the rear guide rail 12 is not only offset with respect to the front guide rail 10 in the vertical direction, however, but also laterally by a spacing X. It is preferably from 0.1 to 15 cm. Since the two guide rails 10 and 12 which are shown in FIG. 1 represent the left-hand (in the driving direction) guide rails of the blind arrangements, the displacement by the spacing X which is shown is a displacement in the direction of the vehicle center. The displacement Z in the vertical direction leads to it being possible for a second, rear blind arrangement which is assigned to the rear guide rail 12 to be mounted further toward the top as viewed from the vehicle interior. This can achieve a situation where, in the case of an identical seat height of the front seats and the rear seats of a vehicle, the headroom in the rear region of the vehicle is increased. The arrangement of the two guide rails 10 and 12 at different heights can also serve, however, to equalize the headroom in the case of a different seat height in the front and rear region of the vehicle in such a way that the headroom is substantially the same substantially below both blind arrangements which are assigned to the vehicle rails 10 and 12. According to the present invention, however, an arrangement at different heights can also take place in such a way that a rear guide rail is arranged with a low installation depth in comparison with the guide rail which lies at the front in the driving direction.

The drive cable is guided through the transfer component 14 in the vertical direction in the form of an S-bend. This means that the transfer component 14 forms an S-bend in a projection onto an imaginary plane which is upright and is oriented in the vehicle longitudinal direction. Here, an S-bend is to be understood to mean a curve which firstly adjoins the outlet opening 16 in a manner which is aligned with the first guide channel in the region of said outlet channel 16, and in turn runs toward the inlet opening 18 in a manner which is aligned with the second guide channel in the region of said inlet opening 18. Two curvatures in opposite directions which firstly bridge the height difference Z are formed between said two horizontally oriented ends 20 and 22 of the transfer component 14.

In the case of smaller spacings Z in the vertical direction between the guide channel of the front guide rail 10 and the guide channel of the rear guide rail 12, it is possible to use a transfer component 14 with merely one S-bend in the vertical direction. Although minimum smallest radii have to be maintained in the case of the two curvatures of the S-bend in a transfer component 14, two curvatures which run merely about horizontal transverse axes can meet this requirement in the case of a correspondingly small spacing Z in the vertical direction of the two guide rails 10 and 12. In the embodiment of FIG. 1, however, greater spacings Z in the vertical direction of the two guide rails can be made possible by way of the additional offset of the two guide rails 10 and 12 with respect to one another by the spacing X in the lateral direction. By virtue of the fact that the guide rails 10 and 12 are offset not only in the vertical direction, but rather also in the lateral direction, a greater height rise Z of the drive cable can be achieved without kinks and with low friction in the case of a predefined spacing Y of the guide rails 10 and 12 in the vehicle longitudinal direction. Since the two curvatures of the transfer component 14 which are shown run in each case about a perpendicular axis and about a vehicle transverse axis as a result of the additional spacing X in the lateral direction, and the transfer component 14 has a greater longitudinal extent than in the case of an offset of the guide rails 10 and 12 with respect to one another merely by a vertical spacing Z, the radii of curvature of the transfer component 14 are increased. Of course, different widths of the roof modules can also be compensated for in this way. In the embodiment of FIG. 1, the transfer component 14 is preferably configured as an injection molded, rigid small tube with integrally molded fastening means such as, for example, a flange 24, by means of which the transfer component 14 is fastened to the rear guide rail 12. In addition to the embodiment in the form of a small plastic tube, however, a metal tube can also be used.

In the embodiment of FIG. 2, as in FIG. 1, a front guide rail 10 and a rear guide rail 12 are likewise depicted. A drive cable 26 is likewise shown for moving blinds of a first and second blind arrangement (not shown) which are assigned in each case to the first guide rail 10 and the second guide rail 12. Instead of a transfer component in the form of a small tube according to FIG. 1, a transfer component 14 is provided here which has a flexible hose piece 28 which is reinforced by means of a reinforcement 30 in such a way that a predefined guide curve of the drive cable 26 through the hose piece 28 with at least one vertical S-bend and optionally also a horizontal S-bend is also achieved here. Here, the reinforcement 30 holds the hose piece 28 in the predefined guide curve, as is achieved by way of the tubular, rigid transfer component 14 of FIG. 1.

A further embodiment of a transfer component according to the invention is depicted in FIG. 3. Two substantial differences are shown here in comparison with the embodiment of FIG. 1. Firstly, the transfer component 14 of FIG. 3 is configured in such a way that two drive cables 26a and 26b can be guided. Furthermore, the transfer component 14 of FIG. 3 is configured as what is known as an alternation. This means that the transfer component 14 does not enclose the drive cables 26a and 26b completely in each case by means of a closed small tube or cylinder, but rather always only in the shape of a part cylinder and in the longitudinal extent of the drive cables 26a and 26b and in the longitudinal orientation of guide channels, as are also configured in the transfer component 14, in an alternating manner in each case in one section 32 from a first side (for example, from above) and in a following section 34 only from the opposite side (that is to say, for example, from the bottom).

### List Of Designations

10 Guide rail
12 Guide rail
14 Transfer component
16 Outlet opening
18 Inlet opening
20 Front end of 14
22 Rear end of 14
24 Flange
26 Drive cable
28 Hose piece
30 Reinforcement
32 Section
34 Section

1. A vehicle roof having a first and a second sunshade arrangement or a first and a second cover for closing a respectively associated opening in the vehicle roof, the sunshade arrangements or the covers being arranged one behind another in the roof longitudinal direction, and it being possible for them to be displaced by at least one drive means which is guided in a manner which is resistant to compression, the drive means being guided in the region of the first sunshade arrangement or the first cover in a first guide channel of a first guide rail, and being guided in the region of the second sunshade arrangement or the second cover in a second guide channel of a second guide rail, wherein a transfer component is provided which transfers the drive means from the first to the second guide channel in a manner which is free from kinks.

2. The vehicle roof as claimed in claim 1, wherein the transfer component imparts to the drive means a predefined guide curve from the first to the second guide channel.

3. The vehicle roof as claimed in claim 1, wherein the first and the second guide channel are arranged offset with respect to one another in the vertical and/or horizontal direction.

4. The vehicle roof as claimed in claim 1, wherein in a region of an outlet opening which is assigned to the second guide channel, the first guide channel is oriented so as to not be aligned with respect to the second guide channel in the region of an inlet opening which is assigned to the first guide channel.

5. The vehicle roof as claimed in claim 2, wherein the guide curve forms an S-bend in the vertical direction.

6. The vehicle roof as claimed in claim 2, wherein the guide curve forms an S-bend in the horizontal direction.

7. The vehicle roof as claimed in claim 2, wherein the guide curve has two curvatures which are configured in such a way that a rectilinear starting section of the guide curve is transferred into an end section of the guide curve, which end section is parallel with respect to said starting section and likewise runs rectilinearly but offset laterally.

8. The vehicle roof as claimed in claim 2, wherein the transfer component is configured as an alternation with a transfer guide channel which lies on the inside, the transfer guide channel defining the guide curve.

9. The vehicle roof as claimed in claim 2, wherein the transfer component is of tubular configuration with a transfer guide channel which lies on the inside, the transfer guide channel defining the guide curve.

10. The vehicle roof as claimed in claim 2, wherein the transfer component has a hose piece for receiving the drive means, and a reinforcing element, by means of which the hose piece is fixed in the predefined guide curve.

11. The vehicle roof as claimed in claim 1, wherein the drive means which is guided in a manner which is resistant to compression is a drive cable which is guided in a manner which is resistant to compression and is guided through the first and the second guide channel and through the transfer component in a manner which is resistant to compression.

12. The vehicle roof as claimed in claim 1, wherein the first and the second sunshade arrangement in each case have a blind arrangement or a sliding headliner.
